(19) United States
(12) Patent Application Publication
(10) Pub. No.: US 2013/0050530 A1
(43) Pub. Date: Feb. 28, 2013

(54) IMAGE CAPTURING DEVICE AND IMAGE PROCESSING METHOD THEREOF

(71) Applicant: CHI-SHENG GE, Tu-Cheng (TW)

(72) Inventor: CHI-SHENG GE, Tu-Cheng (TW)

(73) Assignee: HON HAI PRECISION INDUSTRY CO., LTD., Tu-Cheng (TW)

(21) Appl. No.: 13/457,545

(22) Filed: Apr. 27, 2012

(30) Foreign Application Priority Data
Aug. 30, 2011 (TW) 100131169

(51) Int. Cl. H04N 5/262

(52) U.S. Cl. 348/239; 348/E05.051

(57) ABSTRACT

An image capturing device includes an image capturer, a first detector, a second detector, a processor, a cropping module, a storage module and a display screen. The image capturer captures a temporary image. The first detector obtains endpoint coordinates of the temporary image according to a coordinate system. The second detector detects an inclination of the image capturer and defines a virtual horizon corresponding to the image capturer. The processor receives the endpoint coordinates of the temporary image and virtual horizon and determines a deflection angle of the temporary image. The cropping module crops portions of the temporary image to a normal image based on the deflection angle of the temporary image. The storage module stores the normal image.

### BACKGROUND

1. Technical Field

The present disclosure relates to an image capturing device and image processing method, and more particularly, to an image capturing device which has an image correction function.

2. Description of Related Art

Image capturing devices are used in people's work and study. In order to obtain a high-quality image, an advanced image capturing device may include a level sensing instrument. The level sensing instrument controls the image capturing device to display a virtual horizon on a screen of the image capturing device, such that a user could adjust the orientation of the image capturing device according to the virtual horizon. However, it is difficult to align with the virtual horizon accurately; as a result the image may have a slight skew from the horizon.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a block diagram of an image capturing device according to one embodiment of the present disclosure.

FIG. 2 is a flowchart showing a method for processing an image of the image capturing device of FIG. 1.

FIGS. 3A-3D is an image correction process according to a first embodiment of present disclosure, using the image capturing device of FIG. 1.

FIGS. 4A-4D is an image correction process according to a second embodiment of present disclosure, using the image capturing device of FIG. 1.

### DETAILED DESCRIPTION

Reference will be made to the drawings to describe various embodiments in detail.

In general, the word “detector”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives

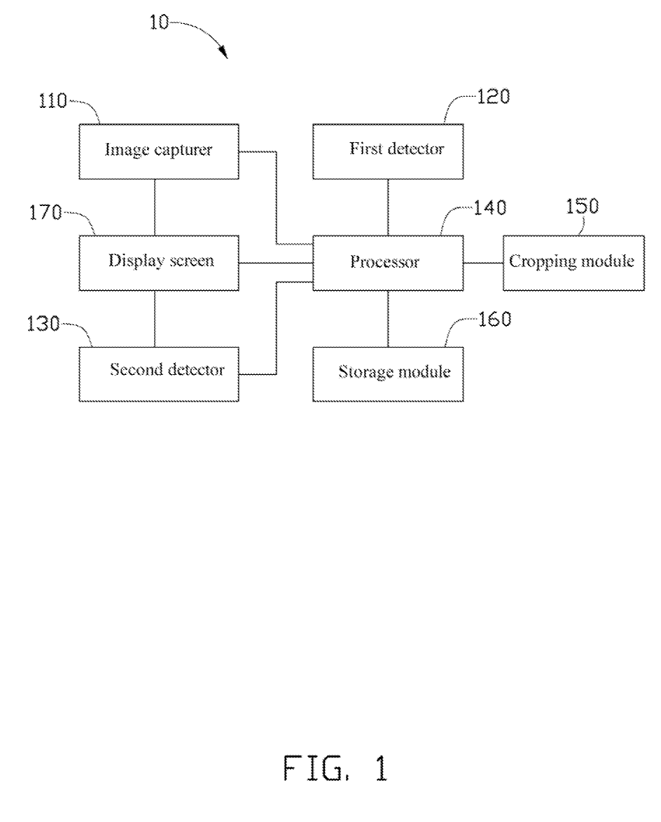

FIG. 1 is a block diagram of an image capturing device 10 according to one embodiment of the present disclosure. The image capturing device 10 may be a camera or a video camera.

The image capturing device 10 includes an image capturer 110, a first detector 120, a second detector 130, a processor 140, a cropping module 150 and a storage module 160. The image capturer 110 is configured to capture a temporary image and send the temporary image to the processor 140. In one embodiment, the image capturer 110 may be CCD lens or CMOS lens. The first detector 120 is configured to obtain coordinates of endpoints of the temporary image according to a coordinate system and send the endpoints coordinates to the processor 140. The second detector 130 is configured to detect a virtual horizon when the image capturer 110 captures the temporary image. The processor 140 is configured to detect a deflection angle of the temporary image relative to the virtual horizon. When the deflection angle is within a predetermined range, such as more than zero degrees and less than a fixed predetermined angle, the cropping module 150 crops the temporary image to achieve a geometrically-horizon normal image. The storage module 160 is configured to store a normal image. In this embodiment, the storage module 160 maybe flash memory or hard disk. In this embodiment, the fixed predetermined angle can be set as ten degrees.

In one embodiment, the image capturing device 10 further includes a display screen 170. When the image capturer 110 captures a temporary image, the display screen 170 displays the virtual horizon which is detected by the second detector 130 and the temporary image. In one embodiment, the second detector 130 can be a three-dimensional sensing instrument, such as a three-dimensional electronic level.

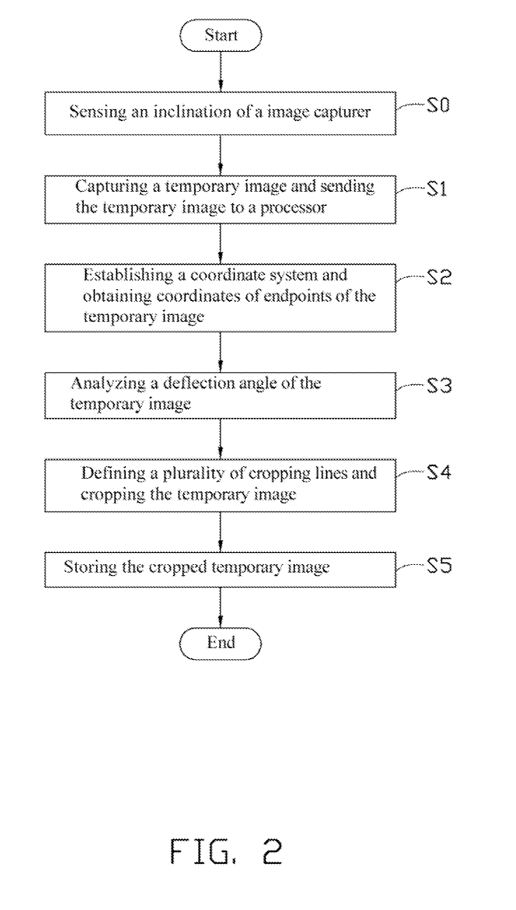

FIG. 2 is a flowchart showing a method for processing images of the image capturing device of FIG. 1. The method includes the following steps, but it should be understood that in other embodiments, additional steps may be added, others deleted, and the ordering of the steps may be changed.

In step S0, the second detector 130 senses inclination of the image capturer 110. A virtual horizon may be defined based on the sensed inclination of the image capturer 110. The virtual horizon may also be displayed on the display screen 170.

In step S1, the image capturer 110 captures a temporary image and sends the temporary image to the processor 140.

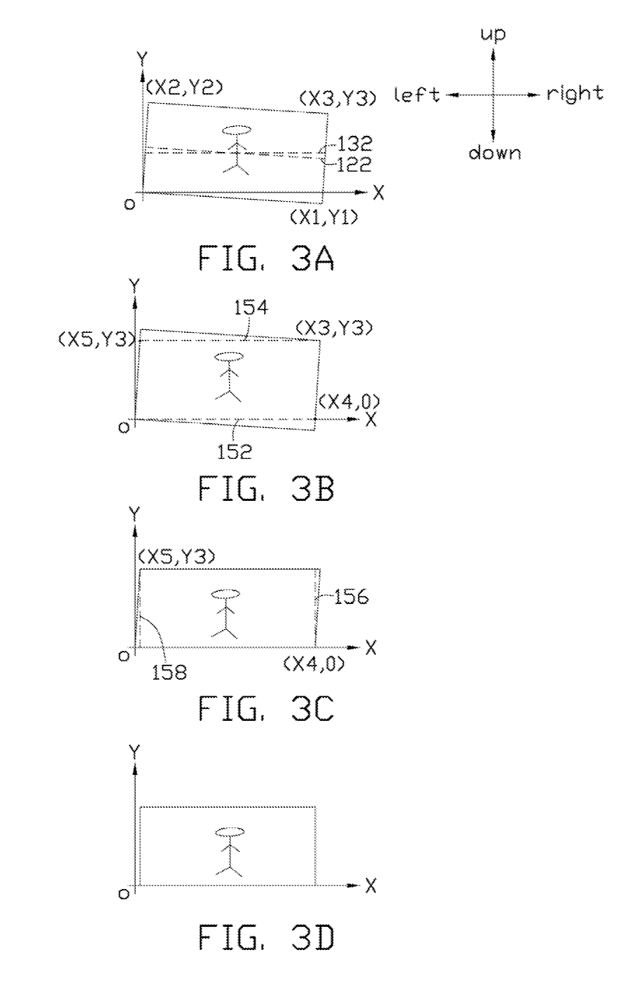

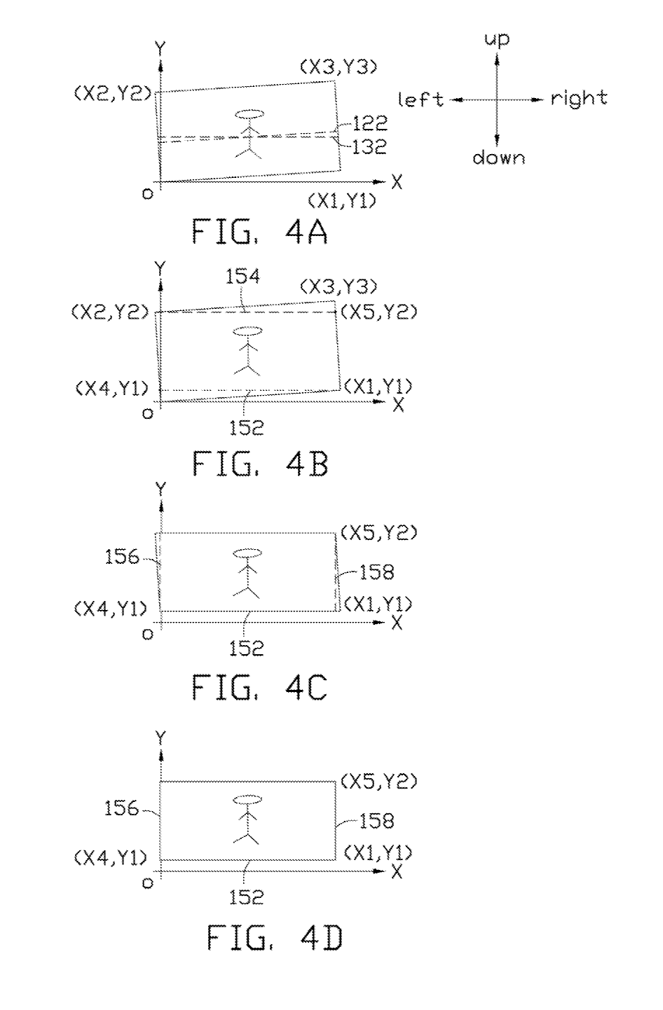

In step S2, the first detector 120 establishes a coordinate system and obtains coordinates of endpoints of the temporary image in the coordinate system. FIGS. 3A-3D show an image correction process according to a first embodiment of present disclosure, using the image capturing device 10. FIGS. 4A-4D show an image correction process according to a second embodiment of present disclosure, using the image capturing device 10. Referring to FIG. 3A or FIG. 4A, the first detector 120 establishes an X-O-Y coordinate system. The “O” is an origin of the coordinate system. In this embodiment, a left-down endpoint of the temporary image is defined as an origin of the X-O-Y coordinate system, the direction of the virtual horizon 132 is defined as an X axis, and a direction of virtual vertical perpendicular to the virtual horizon 132 is defined as a Y axis. Therefore, the inclination of the temporary image in the X-O-Y coordinate system is related to the inclination of the image capturing device 10. The first detector 120 records four endpoint coordinates of the temporary image, the left-down endpoint (0, 0), the right-down endpoint (X1, Y1), the left-up endpoint (X2, Y2), the right-up endpoint (X3, Y3). The first detector 120 determines a midpoint of left edge of the temporary image according to the left-down endpoint (0, 0) and the left-up endpoint (X2, Y2) and a midpoint of right edge of the temporary image according to the right-down endpoint (X1, Y1) and the right-up endpoint (X3, Y3). The first detector 120 further determines a center line 122 according to the midpoint of the left edge and the right edge.

In step S3, the processor 140 analyzes the deflection angle of the temporary image. The processor 140 obtains an inclination angle defined by the center line 122 and the virtual horizon 132, so as to obtain a deflection angle of the temporary image. The processor 140 then analyzes degrees of the inclination angle. In detail, the processor 140 compares the degrees of the inclination angle with the predetermined range. If the deflection angle is within the predetermined range, step S4 is performed. If the deflection angle is not within the predetermined range, step S5 is performed. For example, the predetermined range may be more than zero degrees and less than a fixed predetermined angle. In this embodiment, the fixed predetermined angle can be set as 10 degrees.

In step S4, the cropping module 150 defines a plurality of cropping lines and crops the temporary image along the cropping lines. A first horizon cropping line 152, a second horizon cropping line 154, a first vertical cropping line 156 and a second vertical cropping line 158 are defined for respectively cropping a bottom edge, a top edge, a right edge, and a left edge of the temporary image. The cropping module 150 determines a deflection direction of the temporary image, and the four cropping lines are differently set for different deflection directions. The deflection direction of the temporary image may be determined by the longitudinal coordinate Y1 of the right-down endpoint. When the longitudinal coordinate Y1 is less than zero, referring to FIGS. 3B-3D, the temporary image may be have a first deflection direction, and when the longitudinal coordinate Y1 is more than zero, referring to FIGS. 4B-4D, the temporary image may be have a second deflection direction.

For example, when the temporary image has the first deflection direction, the cropping module 150 sets the first horizon cropping line 152 extending through the left-down endpoint (0, 0). A first intersection point coordinate (X4, 0), where the first horizon cropping line 152 meets the right edge of the temporary image is then recorded. The cropping module 150 sets the second horizon cropping line 154 extending from the right-up endpoint (X3, Y3) to be parallel to the X axis. A second intersection point coordinate (X5, Y3), where the second horizon cropping line 154 meets the left edge of the temporary image, is then recorded. The cropping module 150 firstly crops the temporary image along the first horizon cropping line 152 and the second horizon cropping line 154.

The cropping module 150 further sets the first vertical cropping line 156 extending through the first intersection point coordinate (X4, 0) to be parallel to the Y axis. The cropping module 150 sets the second vertical cropping line 158 extending from the second intersection point coordinate (X5, Y3) to be parallel to the Y axis. The cropping module 150 crops the temporary image along the first vertical cropping line 156 and along the second vertical cropping line 158.

In another example, when the temporary image has the second deflection direction, the cropping module 150 sets the first horizon cropping line 152 extending from the right-down endpoint (X1, Y1) to be parallel to the X axis. A first intersection point coordinates (X4, Y1), where the first horizon cropping line 152 meets the left edge of the temporary image is then recorded. The cropping module 150 sets the second horizon cropping line 154 extending through the left-up endpoint (X2, Y2), to be parallel to the X axis. A second intersection point coordinates (X5, Y2), where the second horizon cropping line 154 meets the right edge of the temporary image, is then recorded.

The cropping module 150 sets the first vertical cropping line 156 extending through the first intersection point coordinate (X4, Y1) to be parallel to the Y axis. The cropping module 150 sets the second vertical cropping line 158 extending through the second intersection point coordinate (X5, Y2) to be parallel to the Y axis.

In step S5, the processor 140 defines the temporary image after cropping as a normal image and stores the normal image in the storage module 160.

In alternative embodiments, the processor 140 can directly obtain the deflection angle of the temporary image from the left-down endpoint (0, 0) and right-down endpoint (X1, Y1). The processor 140 can also obtain the deflection angle of the temporary image according to the inclination of the image capturer 110 which is sensed by the second detector 130.

In another embodiment, the image correction process is similar to the image correction process of FIGS. 3A-3D and FIGS. 4A-4D, except that the cropping module 150 sets the first vertical cropping line and the second vertical cropping line and firstly crops the temporary image in vertical direction, and then sets the first horizon cropping line and the second horizon cropping line and crops the temporary image in horizon direction.

It is believed that the present embodiments and their advantages will be understood from the foregoing description, and it will be apparent that various changes may be made thereto without departing from the spirit and scope of the embodiments or sacrificing all of their material advantages.

What is claimed is:

1. An image capturing device, comprising:
an image capturer configured for capturing a temporary image;
a first detector configured for obtaining four endpoint coordinates of the temporary image according to a coordinate system;
a second detector configured for detecting an inclination of the image capturer and defining a virtual horizon corresponding to the inclination of the image capturer;
a processor configured for receiving coordinates of the four endpoints of the temporary image and the virtual horizon, and determining a deflection angle of the temporary image;
a cropping module configured for cropping the temporary image based on the deflection angle of the temporary image; and
a storage module configured for storing the cropped image.

2. The image capturing device of claim 1, wherein the image capturing device further comprises a display screen, the display screen configured for displaying the temporary image together with the virtual horizon.

3. The image capturing device of claim 2, wherein the coordinate system is an X-O-Y coordinate system, and a left-down endpoint of the temporary image is an origin of the X-O-Y coordinate system, and direction of the virtual horizon is an X-axis of the X-O-Y coordinate system.

4. The image capturing device of claim 3, wherein the first detector determines a center line having a midpoint of left edge and a midpoint of right edge of the temporary image.

5. The image capturing device of claim 4, wherein the processor compares the virtual horizon with the center line to obtain the deflection angle of the temporary image; when the deflection angle is in a predetermined range, the cropping module crops the temporary image to a normal image.

6. The image capturing device of claim 5, wherein the predetermined range is more than zero degrees and less than a fixed predetermined angle.

7. The image capturing device of claim 6, wherein the fixed predetermined angle is ten degrees.

8. The image capturing device of claim 3, wherein the processor acquires the deflection angle by analyzing a left-down endpoint coordinate and a right-down endpoint coordinate.

9. An image processing method, comprising:
capturing a temporary image by an image capturer;
recording coordinates of four endpoints of the temporary image by a first detector;
analyzing a deflection angle of the temporary image according to coordinates of the four endpoints of the temporary image by a processor;
cropping the temporary image when the deflection angle is within a predetermined range by a cropping module; and
storing the cropped temporary image in a storage module.

10. The image processing method of claim 9, wherein the predetermined range is more than zero degrees and less than a fixed predetermined angle.

11. The image processing method of claim 10, wherein the fixed predetermined angle is 10 degrees.

12. The image processing method of claim 9, wherein recording coordinates of four endpoints of the temporary image step comprises establishing an X-O-Y coordinate system, a left-down endpoint of the temporary image is the origin of the X-O-Y coordinate system, the direction of the virtual horizon is X axis; then recording coordinates of the four endpoints of the temporary image.

13. The image processing method of claim 12, wherein cropping the temporary image step comprises setting a first horizon cropping line and a second horizon cropping line, cropping the temporary image in horizon direction along the first horizon cropping line and the second horizon cropping line, setting a first vertical cropping line and a second vertical cropping line, and cropping the temporary image in vertical direction along the first vertical cropping line and the second vertical cropping line.

14. The image processing method of claim 12, wherein cropping the temporary image step comprises setting a first vertical cropping line and a second vertical cropping line, cropping the temporary image in vertical direction along the first vertical cropping line and the second vertical cropping line, setting a first horizon cropping line and a second horizon cropping line, and cropping the temporary image in horizon direction along the first horizon cropping line and the second horizon cropping line.
